(19) United States
(12) Patent Application Publication
(10) Pub. No.: US 2005/0287511 A1
(43) Pub. Date: Dec. 29, 2005

(54) Dynamic curriculum generation system

(75) Inventor: Eric Yang, Taichung (TW)

Correspondence Address: BACON & THOMAS, PLLC, 625 SLATERS LANE, FOURTH FLOOR, ALEXANDRIA, VA, 22314, US

(73) Assignees: MuchTalk, Inc., Taichung City (TW); Eric Yang, Taichung City (TW)

(21) Appl. No.: 10/852,141

(22) Filed: May 25, 2004

(51) Int. Cl. G09B 25/00

(52) U.S. Cl. 434/365; 434/169

(57) ABSTRACT

The present invention provides a dynamic curriculum generation system, which is suitable for language courses or other interactive learning environments for dynamically generating an individual course menu for a client. When the client provides his or her information to the course database of the present invention through a network connection, the application program of the present invention compares the client information with the course database to select at least one course from the course database to generate the individual menu for the client.

### BACKGROUND OF THE INVENTION

1. Field of the Invention

The present invention relates to a data generation system and, more particularly, to a dynamic curriculum generation system for an interactive learning environment.

2. Description of the Related Art

For language learners, greater efficiency is obtained if they can select a curriculum suitable for their language levels, occupations, ages, and even interests.

However, in the typical language learning environment, course content is usually decided by the teaching part; a learner is restricted to a predetermined course menu, or may be able to only select a curriculum or course level with limited options. This can cause the learner to waste time on courses in which he or she is uninterested, and lead to actual disliking of the learning process.

Typical language courses have different levels so that learners who have similar language abilities can take the course together to enhance learning results. However, learners cannot choose their course mates, and so learners with totally different backgrounds may be brought together, leading to miscommunication.

Therefore, it is desirable to provide a dynamic curriculum generation system to mitigate and/or obviate the aforementioned problems.

### SUMMARY OF THE INVENTION

A main objective of the present invention is to provide a dynamic curriculum generation system for networked language courses, or other interactive learning environments, to dynamically generate an individual course menu for a client to perform a language learning process or other process.

Another objective of the present invention is to provide a dynamic curriculum generation system for networked language learning courses, or other interactive learning environments, which enables a plurality of clients to select a common learner characteristic that satisfies their expectations to perform a language learning process or other process.

In order to achieve the aforementioned objective, the dynamic curriculum generation system comprises a course database, a client database and an application program. The course database includes a plurality of courses, each course defining at least one course type and at least one course focus. The client database includes at least client type data and client ability data. The application program includes comparison program code for comparing the course database and the client database to select at least one course from the course database to generate an individual course menu for the client. Furthermore, the present invention enables a plurality of clients to select common learner together.

Other objects, advantages, and novel features of the invention will become more apparent from the following detailed description when taken in conjunction with the accompanying drawings.

### BRIEF DESCRIPTION OF THE DRAWINGS

FIG. 1 is a system structure of a dynamic curriculum generation system according to a first embodiment of the present invention.

FIG. 2 is a system structure of a dynamic curriculum generation system according to a second embodiment of the present invention.

FIG. 3 is a system structure of a dynamic curriculum generation system according to a third embodiment of the present invention.

FIG. 4 is a flowchart of a process of a server.

FIG. 5 is a flowchart of an operating process of the dynamic curriculum generation system.

### DETAILED DESCRIPTION OF THE PREFERRED EMBODIMENT

There will be three embodiments explained in following description.

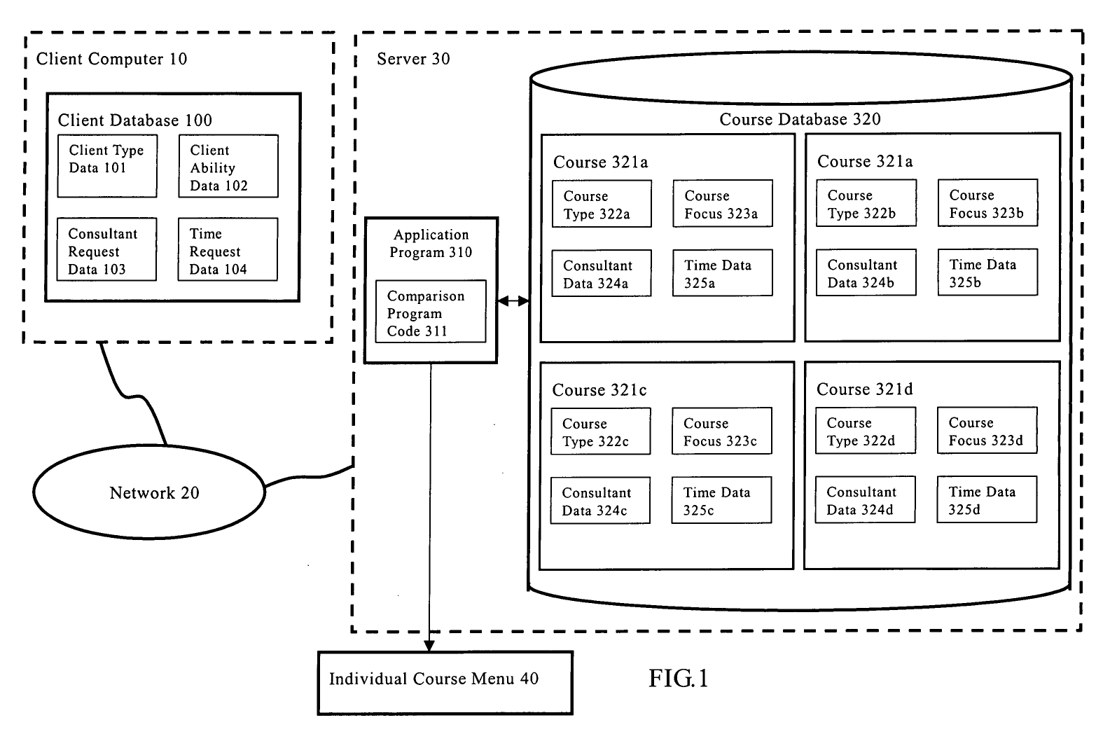

Please refer to FIG. 1. FIG. 1 is a system structure of a dynamic curriculum generation system according to a first embodiment of the present invention. In this embodiment, client database 100 is stored in a client computer 10 and connected to an application program 310 and a course database 320 stored in a server 30 via a network 20. The dynamic curriculum generation system of the present invention is suitable for networked language learning environments and dynamically generates an individual course menu 40 according to the client database 100 provided by a client. The client can execute the language learning process in an online or offline manner according to the individual course menu 40.

In order to execute the language learning process, the client database 100 includes related information about the client who wants to perform the language learning process. The client database 100 may include client type data 101, client ability data 102, consultant request data 103 and time request data 104. However, the client database 100 is not limited to the above-mention content; other data, such as the client's name, age, occupation, sex, interests, financial status, social status, etc., may also be included. Furthermore, in this embodiment, the client database 100 can be provided by the client, or generated by utilizing pre-input data, and this pre-input data can be stored in the client computer 10 or server 30. In the first embodiment, the client type data 101 includes data about the client's orientation with regard to politics, society, business, science, law, literature, art, engineering, etc. The client ability data 102 includes listening ability, conversational ability, reading ability, writing ability, grammar proficiency, pronunciation ability, and vocabulary level of the client in a language. The consultant request data 103 includes data about the consultant requested by the client. The time request data 104 includes data about the time for the language learning process requested by the client. As shown in FIG. 1, the course database 320 includes a plurality of courses 321a, 321b, 321c and 321d. Each course defines at least one course type 322a, 322b, 322c, 322d; at least one course focus 323a, 323b, 323c, 323d; at least one set of consultant data 324a, 324b, 324c, 324d, and at least one set of time data 325a, 325b, 325c, 325d. The data defined by each course is not limited to the above-mentioned content; other data may be provided, such as the course length, the course novelty, the selected frequency of the course, or the popularity of the course.

In this first embodiment, the course type 322a, 322b, 322c, 322d includes data about the types of politics, society, business, science, law, literature, art, engineering, etc. to which the course belongs. The course focus 323a, 323b, 323c, 323d includes data about which aspect of listening, conversation, reading, writing, grammar, pronunciation, and vocabulary the course focuses on. The consultant data 324a, 324b, 324c, 324d includes data about the consultant for each course. The time data 325a, 325b, 325c, 325d includes data about the time for each course.

As shown in FIG. 1, the application program 310 comprises comparison program code 311. When the client computer 10 is connected to the server 30 via the network 20, the comparison program code 311 compares the course database 320 and the client database 100 to select at least one course from the plurality of courses 321a, 321b, 321c and 321d stored in the course database 320 to generate an individual course menu 40.

In this first embodiment, the comparison program code 311 can selectively perform a partial or complete comparison according to one of the following steps corresponding to the request form the client to generate the individual course menu 40:
1. The comparison program code 311 compares every course type 322a, 322b, 322c and 322d to the client type data 101 to generate the individual course menu 40.
2. The comparison program code 311 compares every course focus 323a, 323b, 323c and 323d to the client ability data 102 to generate the individual course menu 40.
3. The comparison program code 311 compares every set of consultant data 324a, 324b, 324c and 324d to the consultant request data 103 to generate the individual course menu 40.
4. The comparison program code 311 compares every set of time data 325a, 325b, 325c and 325d to the time request data 104 to generate the individual course menu 40.

Furthermore, in the first embodiment, every course focus 323a, 323b, 323c and 323d can be further defined as a plurality of levels; for example, training in listening, conversation, reading, writing, grammar, pronunciation, and vocabulary can be divided into twelve levels. Therefore, the comparison program code 311 can further compare every course focus 323a, 323b, 323c and 323d to all levels of the client ability data 102 to generate the individual course menu 40.

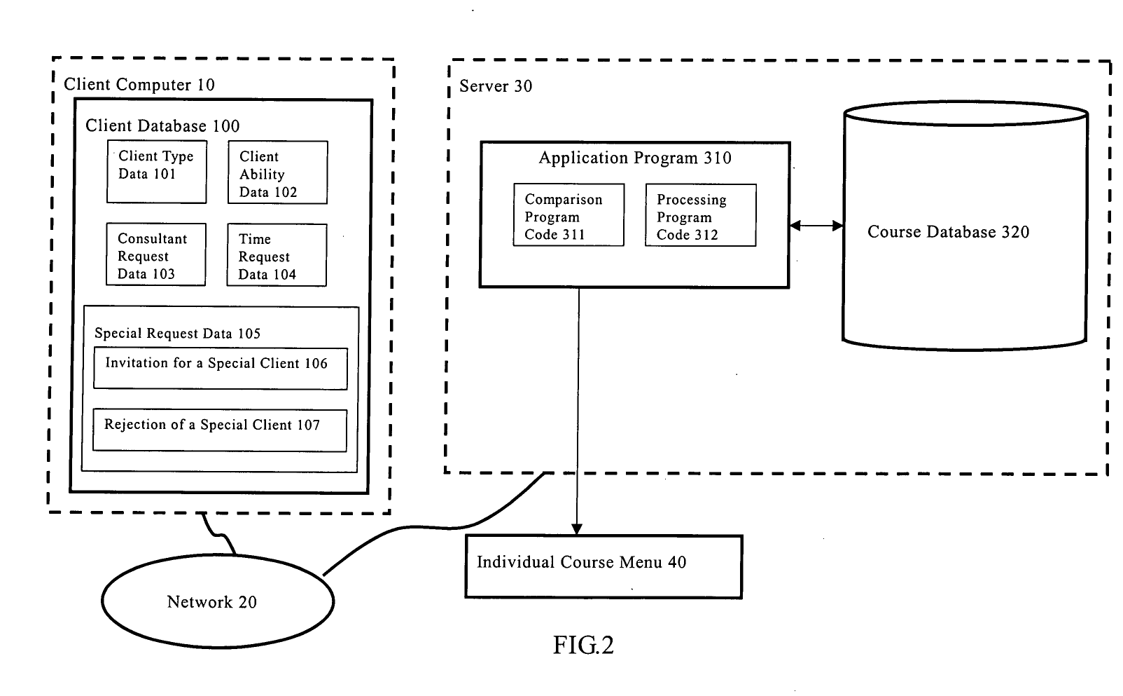

Additionally, the comparison program code 311 can be set to generate the individual course menu 40 when a difference between the level of the client ability data 102 and the level of the course focus 323a, 323b, 323c and 323d is within a predetermined range. For example, if the comparison program code 311 compares three different levels, and the level of the client ability data 102 is a second level, then if the level of the course focus 323a, 323b, 323c and 323d is a first level, a second level or a third level, the comparing program code 311 can generate the individual course menu 40. Please refer to FIG. 2. FIG. 2 is a system structure of a dynamic curriculum generation system according to a second embodiment of the present invention. The difference between the first embodiment and the second embodiment is that the client database 100 further comprises special request data 105, and the application program 310 further comprises processing program code 312 for processing the special request data 105 to generate the individual course menu 40. As shown in FIG. 2, in the second embodiment, the special request data 105 included in the client database 100 comprises an invitation for a special client 106 and a rejection of a special client 107. The invitation for a special client 106 is used for asking a special client to select the same course. The rejection of a special client 107 is used for preventing a special client from selecting the same course. Therefore, after the client inputs the special request data 105, the client can select a particular client with whom to execute the language learning process.

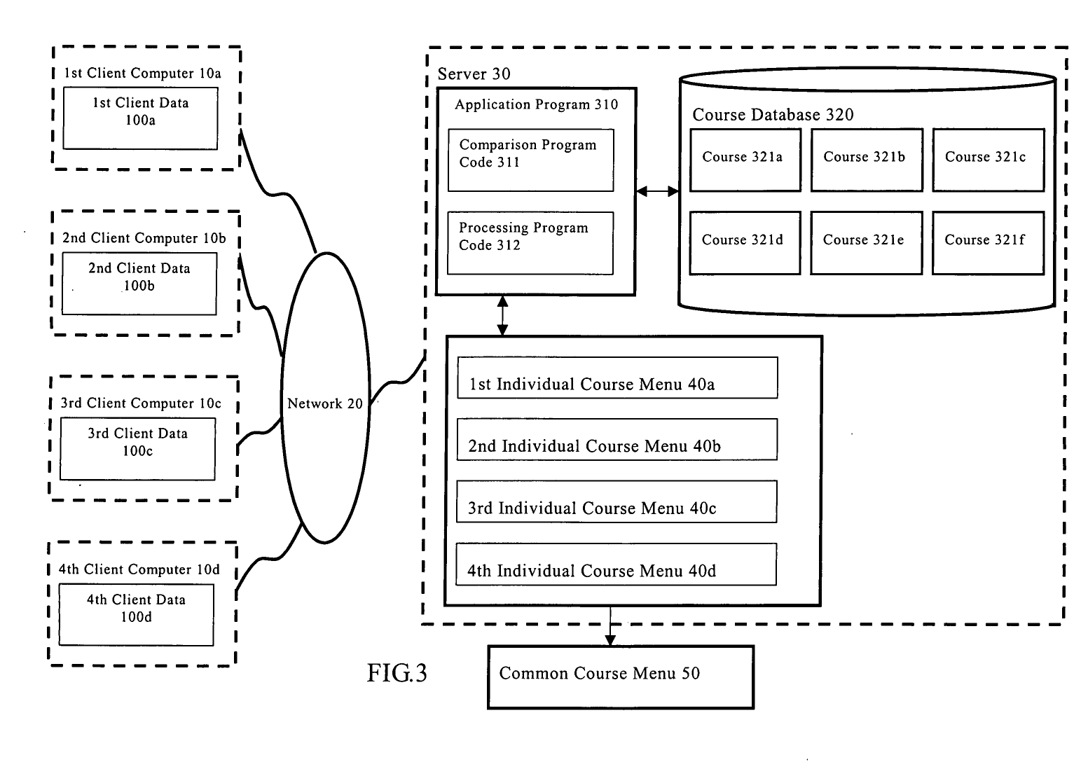

Please refer to FIG. 3. FIG. 3 is a system structure of a dynamic curriculum generation system according to a third embodiment of the present invention. In the third embodiment, a plurality of clients can operate the present invention to generate a common course menu 50.

As shown in FIG. 3, a first client computer 10a, a second client computer 10b, a third client computer 10c and a fourth client computer 10d, which represent a plurality of clients, are connected to the server 30 via the network 20. The comparison program code 311 respectively compares first client database 100a, second client database 100b, third client database 100c, and fourth client database 100d to the courses 321a, 32 1b, 321c, 321d, 321e and 321f according to the individual requests from each client to generate an individual course menu 40a for the first client, an individual course menu 40b for the second client, an individual course menu 40c for the third client, and an individual course menu 40d for the fourth client. Next, the comparison program code 311 compares the individual course menu 40a for the first client, the individual course menu 40b for the second client, the individual course menu 40c for the third client, and the individual course menu 40d for the fourth client to generate a common course menu 50. The common course menu 50 can include one course or several courses depending on how many courses match. Furthermore, in this third embodiment, if any of the client database 100a, 100b, 100c and 100d includes the special request data 105 shown in FIG. 2, the processing program code 312 performs a process to generate the common course menu 50.

According to the above-mentioned three embodiments, the client can login to the server 30 at home, office, school or other place with a networking service, and request the desired course content and common learners to generate the individual course menu 40 or the common course menu 50 and execute the language learning course online or offline.

The above-mentioned three embodiments are only used to explain the spirit and effect of the present invention, and should not be construed to limit the range of the present invention. The present invention is not only suitable for language learning environments, but may also be employed in other learning environments, such as a ball game sports learning environment, a computer course learning environment, and any other learning environment.

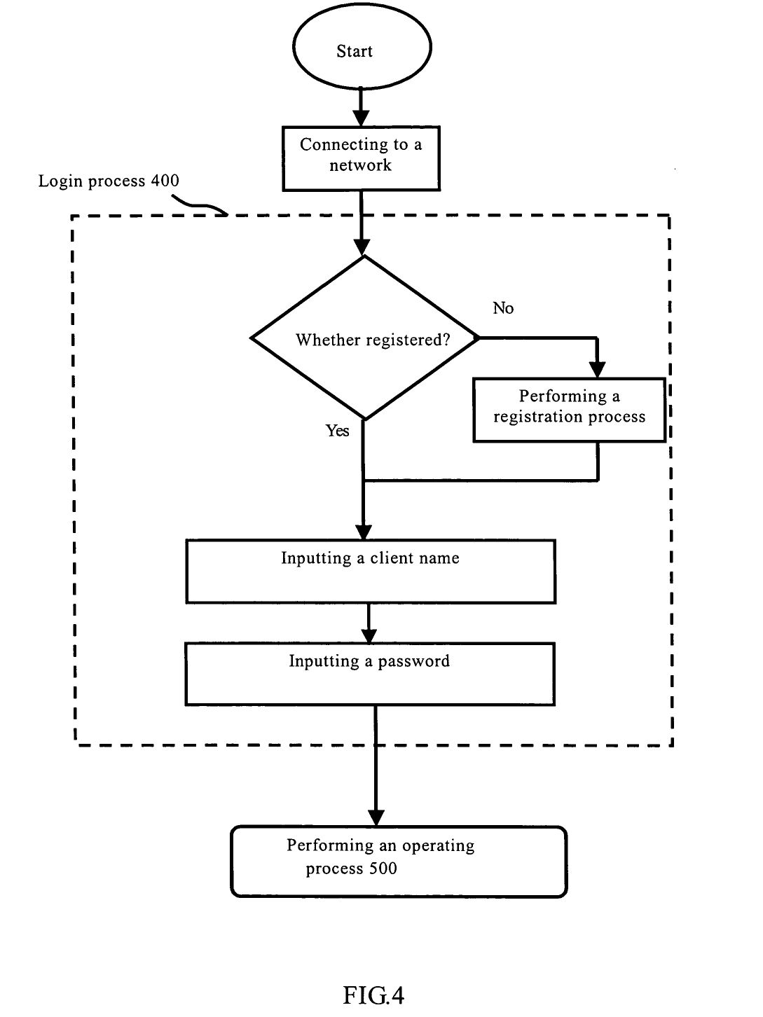

Please refer to FIG. 4. FIG. 4 is a flowchart of a process of a server for the present invention. The client computer 10 is connected to the network 20 and then performs a login process 400 with the server. In the present invention, the registration status of the learner must be verified; otherwise a registration process is first performed. Next., a client name and password input by the client are verified; if they are correct, an operating process 500 of the dynamic curriculum generation system is performed. As the login process 400 of the server is a well-known technique, no further description is required.

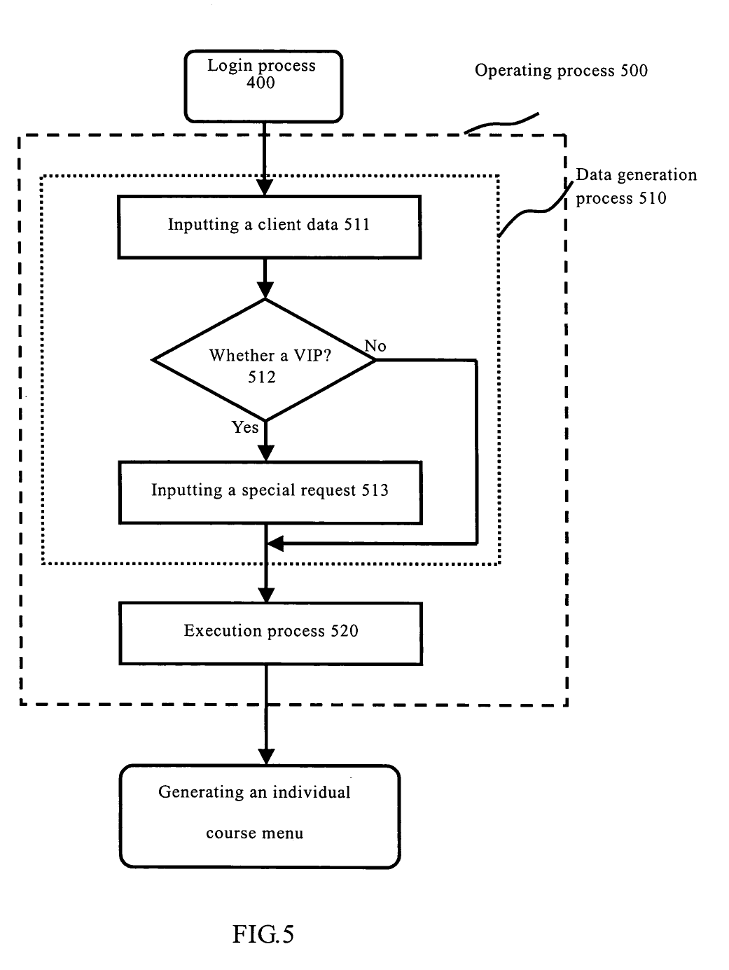

Please refer to FIG. 5. FIG. 5 is a flowchart of an operating process 500 of the dynamic curriculum generation system. After the client computer 10 finishes the login process 400 of the server 30, the operating process 500 of the dynamic curriculum generation system is performed. For the operating process 500 of the dynamic curriculum generation system, the client computer 50 first performs a data generation process 510 to generate the client database 100 shown in FIG. 1. In the data generation process 510, the client needs to perform a client data input process 511, which can be achieved by the client inputting client data, or by calling upon pre-stored client database in the client computer 10 or in the server 30. Next, the server 30 performs a verification process 512 to determine if the client is a VIP client; in other words, to verify if the client is a client having authorization to input the special request data 105. If the client has the authorization to input the special request data 105, the client can perform an input process 513 to input a special request, selectively inputting an invitation for a special client 106 and/or a rejection of a special client 107.

After finishing the input process 510 of client database, an execution process 520 for the application program is performed to execute the comparison program code 311 and/or the processing program code 312 to select at least one course from the course database 320 and generate the individual course menu 40.

Finally, to be noted is that the processes shown in FIG. 4 and FIG. 5 need not all necessarily be performed. Part of one process, or the entirety of a process, can be skipped while still achieving the purposes of the present invention. For example, the verification process 512 shown in FIG. 5 can be skipped without difference.

Although the present invention has been explained in relation to its preferred embodiment, it is to be understood that many other possible modifications and variations can be made without departing from the spirit and scope of the invention as hereinafter claimed.

1. A dynamic curriculum generation system for dynamically generating an individual course menu for a client, the system comprising:
a course database including a plurality of courses, each course defining at least one course type and at least one course focus;
a client database including at least client type data and client ability data; and
an application program including comparison program code for comparing the course database and the client database to select at least one course from the course database to generate the individual course menu for the client.

2. The system as claimed in claim 1 wherein the course type is selected from the group consisting of politics, society, business, science, law, literature, art, and engineering.

3. The system as claimed in claim 1 wherein the course focus is selected from the group consisting of listening, conversation, reading, writing, grammar, pronunciation, and vocabulary.

4. The system as claimed in claim 1 wherein the client type data is selected from the group consisting of politics, society, business, science, law, literature, art, and engineering.

5. The system as claimed in claim 1 wherein the client ability data is selected from the group consisting of listening ability, conversational ability, reading ability, writing ability, grammar proficiency, pronunciation ability, and vocabulary level.

6. The system as claimed in claim 1 wherein the course database and the application program are installed on a server, and the client database is installed on a client computer connected to the server via a network connection.

7. The system as claimed in claim 6 wherein the comparison program code compares the course type of each course and the client type data to generate the individual course menu.

8. The system as claimed in claim 7 wherein the comparison program code further compares the course focus of each course and the client ability data to generate the individual course menu.

9. The system as claimed in claim 8 wherein each course further comprises consultant data, the client database further comprising consultant request data, and the comparison program code further compares the consultant data and the consultant request data to generate the individual course menu.

10. The system as claimed in claim 9 wherein each course further comprises time data, the client database further comprises time request data, and the comparison program code further compares the time data and the time request data to generate the individual course menu.

11. The system as claimed in claim 10 wherein each course focus further defines a plurality of levels, the client ability data further comprises level data, and the comparison program code further compares the level of each course focus and the level data of the client ability data to generate the individual course menu.

12. The system as claimed in claim 11 wherein the comparison program code further compares the individual course menu generated for each client to generate a common course menu.

13. The system as claimed in claim 12 wherein the client database further comprises special request data, and the application program further comprises processing program code for processing the special request data to generate the common course menu.

14. The system as claimed in claim 13 wherein the special request data comprises an invitation for a special client for asking a special client to select the same course.

15. The system as claimed in claim 14 wherein the special request data comprises a rejection of a special client for preventing a special client from selecting the same course.
